(19) United States
(12) Patent Application Publication
(10) Pub. No.: US 2009/0195119 A1
(43) Pub. Date: Aug. 6, 2009

(54) Varying commutator bar widths, slot sizes and spacing

(75) Inventors: Martin Volkening, West Lorne (CA); Klaus Werner, Kincardine (CA)

Correspondence Address: Manelli Denison & Selter PLLC, 2000 M Street. N.W., Suite 700, Washington, DC, 20036, US

(73) Assignee: Continental Automotive Canada Inc., Chatham (CA)

(21) Appl. No.: 12/068,401

(22) Filed: Feb. 6, 2008

(51) Int. Cl. H01R 39/04; H01R 43/06

(52) U.S. Cl. 310/233; 29/597

(57) ABSTRACT

A commutator (10) includes a core (12) having a generally annular periphery (15). A plurality of commutator bars (14) is provided in a spaced relation about the periphery of the core. At least two of the commutator bars have a width different from each other.

### FIELD OF THE INVENTION

The present invention relates to commutators used in permanent magnet DC motors for vehicles and, more particularly, to an improved commutator having unequally spaced bars.

### BACKGROUND OF THE INVENTION

Commutators are used in permanent magnet DC motors for switching copper windings in conjunction with brushes riding on the commutator bars. A conventional configuration is a ten bar, copper shell commutator, which has evenly spaced bars at 36° increments around a periphery of a core of the commutator. The copper bars are mounted on the resin core that has an axial hole there-through to allow mounting of the commutator onto the armature. Air gaps between the bars of the commutator are used to electrically insulate the bars from each other. The slots or gaps between the bars are also uniformly size, with the bars spaced equally form each other.

One problem with the conventional commutator configuration is that the commutator bars on the surface of the commutator are equally sized and spaced. The even spacing of the bars causes noise problems by creating a regular, noticeable, order-driven noise due to the brushes impacting on each bar as the commutator rotates underneath them. This order driven noise can be picked up by the untrained person's ear. Thus, this noise is a problem due to noise specifications on HVAC motors and the desire to deaden the mechanical noise the motor produces.

Thus, there is a need to provide a commutator that reduces noise.

### SUMMARY OF THE INVENTION

An object of the invention is to fulfill the need referred to above. In accordance with the principles of an embodiment of the present invention, a commutator includes a core having a generally annular periphery. A plurality of commutator bars is provided in spaced relation about the periphery of the core. At least two of the commutator bars have a width different from each other thereby reducing the regularity of impacts on the commutator and reducing the mechanically produced order noises from the commutator and impacting brushes.

In accordance with another aspect of the invention, a commutator includes a core having a generally annular periphery, and a plurality of commutator bars are provided in uneven spaced relation about the periphery of the core.

In accordance with yet another aspect of the invention, a method provides a commutator having a core with a generally annular periphery. A plurality of commutator bars is mounted in uneven spaced relation about the periphery of the core.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of a commutator provided in accordance with an embodiment of the invention.

FIG. 2 is a plan view of the commutator of FIG. 1 showing spacing angles between commutator bars.

### DETAILED DESCRIPTION OF THE EXEMPLARY EMBODIMENTS

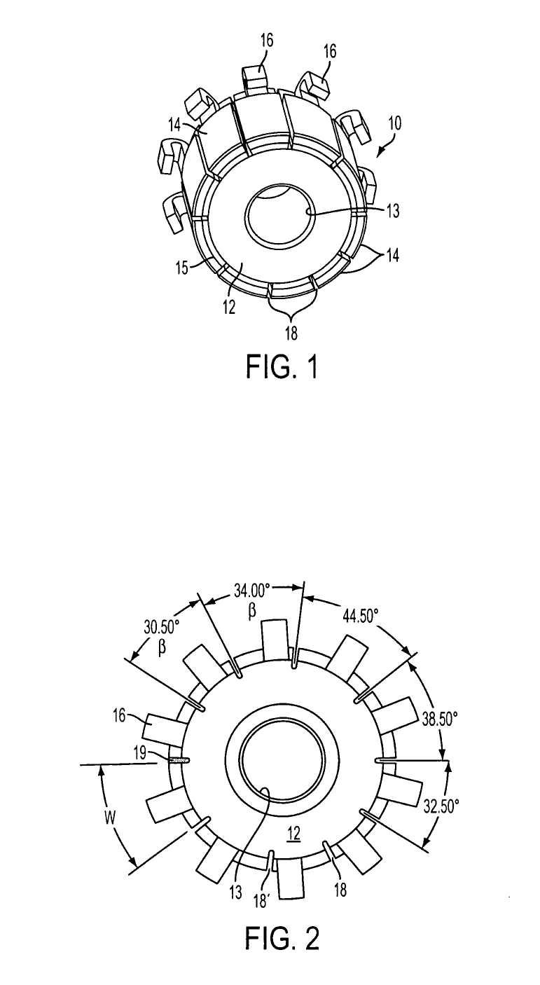

With reference to FIG. 1, a commutator is shown, generally indicated at 10, in accordance with an embodiment of the invention. The commutator 10 includes a resin core 12. The core 12 includes a bore 13 there-through for use in mounting to an armature (not shown) of a permanent magnet DC motor (not shown). A plurality of copper commutator bars 14 are provided in spaced relation about the generally annular periphery 15 of the core 12.

In accordance with the embodiment of the invention, the commutator 10 has unequally spaced commutator bars 14 and thus uneven bar insulation. Each bar 14 carries one hook 16. The hooks 16 are evenly spaced about the periphery of the core 12. When reference to FIG. 2, when two or more bars 14 are used on the commutator 10, the width W of each bar 12 is variable. As a result, the angle β defined between adjacent slots or spaces 18 is variable. This allows for each bar 14 to the have a different (arbitrary) spacing (e.g., angle β in FIG. 2) from the other bars 14 on the periphery 15 of the core 12. The difference in spacing is larger than standard industry production tolerances. The bar 14 width W is not required to be the same as another bar on the commutator 10, however it is possible that bar widths W may be repeated on the commutator 10 in a pattern (e.g., 90° or 180°) due to manufacturing constraints. It is noted that the widths W of the bars 12 can be constant with the spacing between the bars being variable (e.g., space 18 is different from space 18′ in FIG. 2).

Each bar 14 is also electrically insulated from each other with any suitable material such as air or resin 19 filling the spaces 18, 18′. The width of the insulation spaces 18, 18′ (FIG. 2) can also be arbitrary or equal, and can either be randomly sized or made equal around the periphery of the core 12.

It is noted that FIGS. 1 and 2 show a commutator 10 having 180° symmetry as well with a sinusoidal (rising and falling) distribution of angles β but the commutator 10 is not limited to this illustrated embodiment.

Providing the commutator 10 with bars 12 having variable widths W assists in solving the problem of dominant order driven noise. Computer sound analysis has shown that the commutator 10 provides a reduction in the order driven noise as compared to a commutator with evenly spaced (and with even width) commutator bars. This is due to eliminating the regularity of the impacts on the commutator, thereby reducing the mechanically produced order noises from the commutator and brush.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A commutator comprising:
a core having a generally annular periphery, and
a plurality of commutator bars provided in spaced relation about the periphery of the core, wherein
a width and thus a volume of an insulation space between two adjacent commutator bars is different from a width and thus a volume of another insulation space between two other adjacent commutator bars.

2. The commutator of claim 1, wherein an angle between spaces of an associated commutator bar is different from an angle between spaces associated with a different commutator bar.

3. The commutator of claim 1, wherein each bar includes a hook, the hooks being spaced evenly about the periphery of the core.

4. The commutator of claim 1, wherein the insulation space between each commutator bar is filled with insulating material.

5. The commutator of claim 4, wherein the insulating material is resin.

6. A commutator comprising:
a core having a generally annular periphery, and
a plurality of commutator bars provided in spaced relation about the periphery of the core, wherein
at least two of the commutator bars have a width different from each other, and
commutator bars disposed 180° apart have the same width, the bar widths being repeated in a 180° pattern.

7. A commutator comprising:
a core having a generally annular periphery, and
a plurality of commutator bars provided in spaced relation about the periphery of the core, wherein
at least two of the commutator bars have a width different from each other, and
a width and thus a volume of an insulation a space between two adjacent commutator bars is different from a width and thus a volume of another insulation space between two other adjacent commutator bars.

8. (canceled)

9. (canceled)

10. (canceled)

11. (canceled)

12. (canceled)

13. (canceled)

14. (canceled)

15. (canceled)

16. (canceled)

17. (canceled)
